(19) United States
(12) Patent Application Publication
(10) Pub. No.: US 2013/0226550 A1
(43) Pub. Date: Aug. 29, 2013

(54) SYSTEMS AND METHODS FOR MODELING COMPOUND FORMULATIONS

(71) Applicant: Hassan Benameur, Colmar (FR)

(72) Inventor: Hassan Benameur, Colmar (FR)

(21) Appl. No.: 13/403,229

(22) Filed: Feb. 23, 2012

(51) Int. Cl. G06G 7/58

(52) U.S. Cl. 703/12

(57) ABSTRACT

Systems and methods for modeling a compound formulation are provided. In one implementation, a method consistent with the disclosure comprises receiving compound parameters including an excipient parameter identifying an excipient combination to be used in developing the compound formulation and a water concentration parameter identifying a water concentration to be used in diluting the excipient combination; storing, in a database, formulation data associated with a plurality of excipient combinations and solubility data associated with a plurality of pharmaceutical ingredients dissolved in the respective excipient combinations; transforming the formulation data and the solubility data into a formulation model space, where points in the formulation model space reflect compositions of the identified excipient combination; and generating a compound formulation model based on the formulation model space, where the compound formulation model graphically identifies one or more compositions of the identified excipient combination that satisfy the compound parameters.

### FIELD OF THE DISCLOSURE

This disclosure generally relates to systems and methods for modeling compound formulations based on solubility data.

### BACKGROUND OF THE DISCLOSURE

The number of poorly water-soluble drug candidates has risen sharply, particularly with recent progress in combinatorial chemistry and high-throughput screening. Development of oral formulations for such compounds can pose significant challenges at all stages of drug development. Insufficient bioavailability of these compounds due to their low solubility may result in delays in development or cause them to be dropped from the product development pipeline.

Identifying an appropriate vehicle with satisfactory solubility and stability (both chemical and physical) can take significant resources. For compounds that do not dissolve in a small set of commonly-used excipients, there are a large number of permutations that may need to be tested (e.g., combinations of excipients, ratios, and processing conditions). Moreover, performing tests using conventional screening assays can be time-consuming and labor-intensive. Screening assays may also require a large amount of the compound to be tested. As a result, screening assays are not ideal when compound availability and testing time are limited.

Given these challenges, the number and types of formulations that can be tested are often limited by the compound's availability and the time available for the testing. When there is no formulation that provides adequate solubility and absorption for an initial evaluation in an in-vivo study, a compound may not advance in the development cycle. Therefore, there is a great need to develop more effective and efficient screening methods for evaluating and discovering solubility-enhancing formulations outside of conventional approaches.

### SUMMARY OF THE DISCLOSURE

In accordance with the disclosure, a method for modeling a compound formulation is provided. The method comprises receiving compound parameters including an excipient parameter identifying an excipient combination to be used in developing the compound formulation and a water concentration parameter identifying a water concentration to be used in diluting the excipient combination; storing, in a database, formulation data associated with a plurality of excipient combinations and solubility data associated with a plurality of pharmaceutical ingredients dissolved in the respective excipient combinations; transforming the formulation data and the solubility data into a formulation model space, where points in the formulation model space reflect compositions of the identified excipient combination; and generating a compound formulation model based on the formulation model space, where the compound formulation model graphically identifies one or more compositions of the identified excipient combination that satisfy the compound parameters.

According to alternative embodiments of the disclosure, a non-transitory computer-readable medium is provided. The non-transitory computer-readable medium comprises instructions, which, when executed by one or more processors, causes the one or more processor to perform a method for modeling a compound formulation. The method comprises receiving compound parameters including an excipient parameter identifying an excipient combination to be used in developing the compound formulation and a water concentration parameter identifying a water concentration to be used in diluting the excipient combination; storing, in a database, formulation data associated with a plurality of excipient combinations and solubility data associated with a plurality of pharmaceutical ingredients dissolved in the respective excipient combinations; transforming the formulation data and the solubility data into a formulation model space, where points in the formulation model space reflect compositions of the identified excipient combination; and generating a compound formulation model based on the formulation model space, where the compound formulation model graphically identifies one or more compositions of the identified excipient combination that satisfy the compound parameters.

Additional objects and advantages of the embodiments will be set forth in part in the description which follows, and in part will be obvious from the description, or may be learned by practice of the embodiments. The objects and advantages of the disclosure will be realized and attained by means of the elements and combinations particularly pointed out in the appended claims.

It is to be understood that both the foregoing general description and the following detailed description are exemplary and explanatory only and are not restrictive of the disclosure, as claimed.

The accompanying drawings, which are incorporated in and constitute a part of this specification, illustrate one (several) embodiment(s) of the disclosure and together with the description, serve to explain the principles of the disclosure.

### BRIEF DESCRIPTION OF THE DRAWINGS

The accompanying drawings, which are incorporated in and constitute a part of this specification, illustrate example embodiments of the disclosure and together with the description, serve to explain the principles of the present disclosure. In the drawings:

FIG. 1 is a schematic diagram of a system for modeling compound formulations according to an exemplary embodiment;

FIG. 2 is a schematic diagram of a formulation modeling server of the system shown in FIG. 1;

FIG. 3 is a flow chart of a process for modeling compound formulations, according to an exemplary embodiment;

FIG. 4A illustrates an exemplary interface for receiving formulation data and excipient data;

FIG. 4B illustrates an exemplary compound formulation model for providing formulation modeling in one-excipient formulations;

FIG. 4C illustrates an exemplary compound formulation model for providing formulation modeling in two-excipient formulations;

FIG. 4D illustrates an exemplary compound formulation model for providing formulation modeling in three-excipient formulations;

FIG. 4E illustrates an exemplary three-dimensional compound formulation model for three-excipient formulations; and

FIG. 4F illustrates another exemplary three-dimensional compound formulation model for three-excipient formulations.

### DESCRIPTION OF THE EMBODIMENTS

Reference will now be made in detail to the embodiments disclosed herein, examples of which are illustrated in the accompanying drawings. Wherever possible, the same reference numbers will be used throughout the drawings to refer to the same or like parts.

The exemplary embodiments consistent with this disclosure relate to modeling systems and methods for modeling compound formulations during a product development cycle. The system generates a multi-variable formulation model and provides formulation discovery, based on the generated model, for a given pharmaceutical ingredient and excipient combination. In addition, the formulation model provide estimations on dilutability for a compound including one or more excipient components. As described in more detail below, the formulation modeling system provides a beneficial alternative to conducting time-consuming essay screenings, but still identifies to a developer the excipient combinations having desired solubility and stability for the particular pharmaceutical ingredient.

The formulation modeling system may generate the multi-variable formulation model based on formulation data. The formulation data reflect various properties and characteristics of the pharmaceutical ingredient and the excipient components. For example, the formulation data may include the solubility of the pharmaceutical ingredient in individual excipients. The formulation data may further include phase data of a plurality of excipients when they are mixed.

The multi-variable formulation model generated according to the process described herein provides modeling for various aspects of a compound formulation process. According to one embodiment, the formulation model may provide phase information of two or more excipient components selected to form a compound. Depending upon the composition of the excipient combination, the formulation model may determine the phase information of a resulting solution. The phase information, as indicated by the multi-variable formulation model, may be chosen from a two-phase solution, a milky solution, a cloudy solution, a translucent solution, or a transparent solution.

According to another embodiment, the formulation model may provide estimations on the stability of the resulting excipient combination, when it is diluted in other solvents, such as water, to various concentrations. As a result, the formulation model may identify compositions of excipient combinations that have desired stability. According to still another embodiment, the formulation model may provide information on compound formulations that satisfy formulation requirements specified by a user. For example, the formulation requirements may specify a pharmaceutical ingredient, a capsule volume, a dosage, an excipient combination, etc. For the given pharmaceutical ingredient, the formulation model may identify the compositions of the excipient combination that are suitable to provide the user-specified formulation requirements.

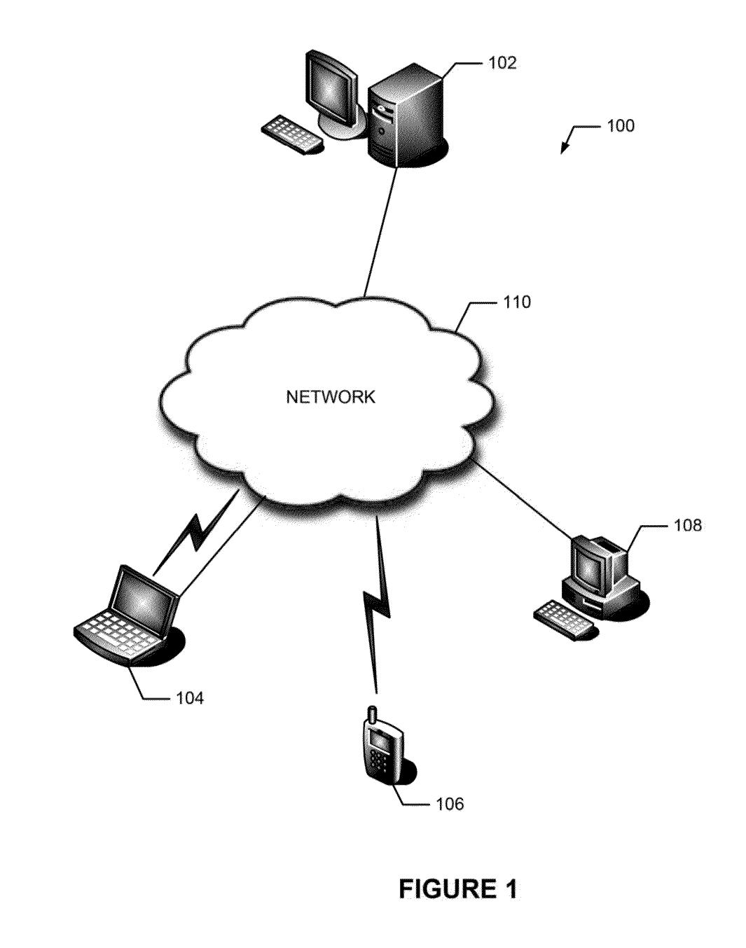

FIG. 1 illustrates an exemplary embodiment of a formulation modeling system 100 for modeling compound formulations during a development cycle. As shown, system 100 may include a formulation modeling server 102 and one or more formulation modeling clients 104, 106, and/or 108. Formulation modeling server 102 and clients 104, 106, and 108 may communicate with one another through a network 110.

Network 110 may be a wired or wireless computer network. For example, network 110 may be a wide area network (WAN), a local area network (LAN), a Wi-Fi network, a Bluetooth network, or a combination of various types of network. Network 110 may operate based on one or more network protocols known in the art. For example, network 110 may use the Internet protocol, the Ethernet protocol, the Synchronous Optical Network (SONET) protocol, the Asynchronous Transfer Mode (ATM) protocol, or a combination of these protocols. Network 110 may transmit formulation data and related commands among formulation modeling server 102 and clients 104, 106, and 108 using, for example, data packets or established routes.

Formulation modeling server 102 (hereinafter referred to as “server 102”) includes a computer system with a formulation modeling server application (hereinafter referred to as “the server application”) stored thereon. The server application, when executed by server 102, may interact with users through user interfaces. For example, server 102 may generate an input interface to receive data inputs from users through a keyboard, a mouse, or other input devices. The user-input data may include data related to drug formulations obtained during formulation screening conducted in laboratory experiments.

The server application, when executed by server 102, may thus communicate with formulation modeling clients 102, 104, and 108 through network 110. For example, the server application may transmit formulation data or related control commands to formulation modeling clients 102, 104, and 108 for the clients to generate user interfaces and to interact with users of the clients. In addition, the server application may also receive formulation data or related control commands, such as user-input data and user requests, from individual clients 104, 106, and 108. The server application may then process the formulation data and respond to the user requests.

Formulation modeling clients 104, 106, and 108 (hereinafter referred to as “clients 104, 106, and 108”) may include computing devices, such as laptops, smart phones, or desktop computers. Clients 104, 106, and 108 may each include a formulation modeling client application (hereinafter referred to as “the client application”) stored thereon. The client application, when executed by the client, may interact with users and communicate with the server application. The client application may be implemented by a web browser, such as INTERNET EXPLORER, FIREFOX, or CHROME. Alternatively, the client application may be a proprietary application, which is customized for modeling various compound formulations consistent with the embodiments disclosed herein.

The client applications on clients 102, 104, and 108 may communicate and interact with the server application on server 102 through a web address, an IP address, or an Internet link, e.g., a URL. The client application may receive formulation data and related control commands from the server application and generate one or more user interfaces on a display device to interact with the user. Through the user interfaces, the client application allows the user to input data or commands through a keyboard or a mouse to request formulation modeling for a given pharmaceutical ingredient and excipient combinations. The server application on server 102 may respond to the user request and carry out the formulation modeling described herein.

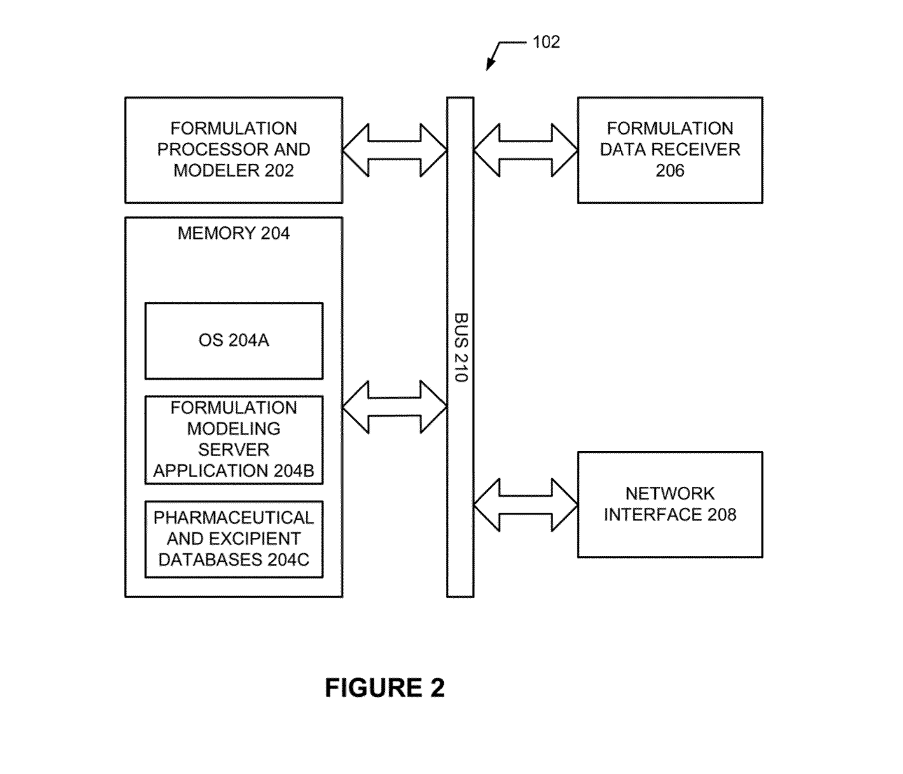

FIG. 2 illustrates an exemplary embodiment of server 102 shown in FIG. 1. As shown, server 102 may include a formulation processor and modeler 202, a memory 204, an formulation data receiver 206, and a network interface 208. The components of server 102 may communicate with one another through a system bus 210.

Formulation processor and modeler 202 includes a processor, such as an INTEL processor or an AMD processor, which may receive data related to compound formulations from memory 204 or formulation data receiver 206 and execute program instructions to process the data. In addition, formulation processor and modeler 202 may receive user commands or requests and process the formulation data in response to the user commands or requests. For example, formulation processor and modeler 202 may receive, through network interface 208, a user request for a formulation modeling based on a specific pharmaceutical ingredient and excipient combination. Formulation processor and modeler 202 then retrieves formulation data corresponding to the compound formulation from memory 204 and processes the formulation data according to program instructions of the server application. The processing of the formulation data is further described below.

Memory 204 may include a read only memory (ROM), a random access memory (RAM), a flash memory, a hard disc, etc. Memory 204 may include a plurality of sections for storing programs and data. As shown in FIG. 2, for example, memory 204 includes an OS section 204A for storing instructions of an operating system, such as MICROSOFT WINDOWS or LINUX. The program codes in OS section 204A are executed by formulation processor and modeler 202 to provide an operating environment for executing the server application.

Memory 204 further includes an application section 204B for storing instructions of the server application, which are executed by formulation processor and modeler 202 to model the compound formulation and provide formulation estimations in response to the user request. The instructions of the server application may be written in a programming language known in the art, such as C, C++, BASIC, HTML, XML, etc and executed by formulation processor and modeler 202 in response to a user input or a control command. The instructions of the server application stored in application section 204B include control and data processing logic, which may cause formulation processor and modeler 202 to perform various operations in connection with the compound formulation modeling described herein.

Memory 204 further includes a data section 204C for storing one or more formulation and solubility databases. The databases include information related to a number of pharmaceutical ingredients and solubility data in connection with the compound formulations described herein. Formulation processor and modeler 202, by executing the instructions of the server application, may retrieve or modify the data stored in the databases of section 204G.

Formulation data receiver 206 includes, for example, a keyboard interface, a mouse interface, a touch pad interface, an USB interface, etc. Formulation data receiver 206 may communicate with peripheral components, such as a keyboard, a touch pad, a mouse, or a USB device to receive formulation data from users. Additionally, formulation data receiver 206 may provide communications between server 102 and an external system for automated essay screening. Sever 102 may receive formulation data obtained during essay screening from the external system.

Network interface 208 may be an Ethernet adaptor, a Wi-Fi wireless network adaptor, a Bluetooth adaptor, etc. Network interface 208 provides network communications between server 102 and network 110 and allows server 102 to communicate with clients 104, 106, and 108. Network interface 208 may receive data and control commands from the client applications on clients 104, 106, and 108 and transmit data and control commands to clients 104, 106, and 108.

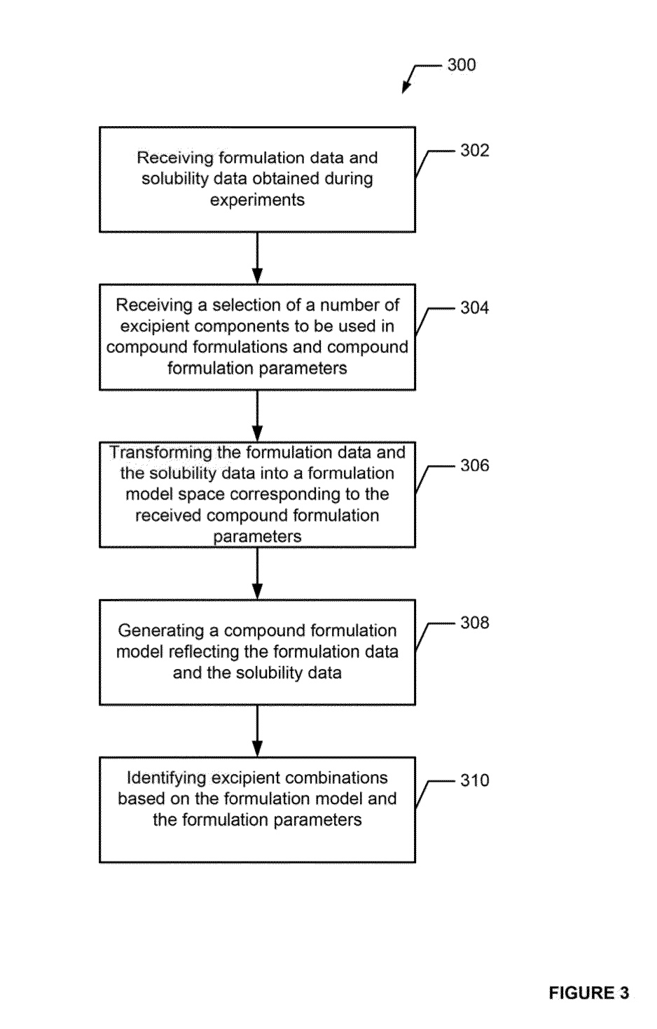

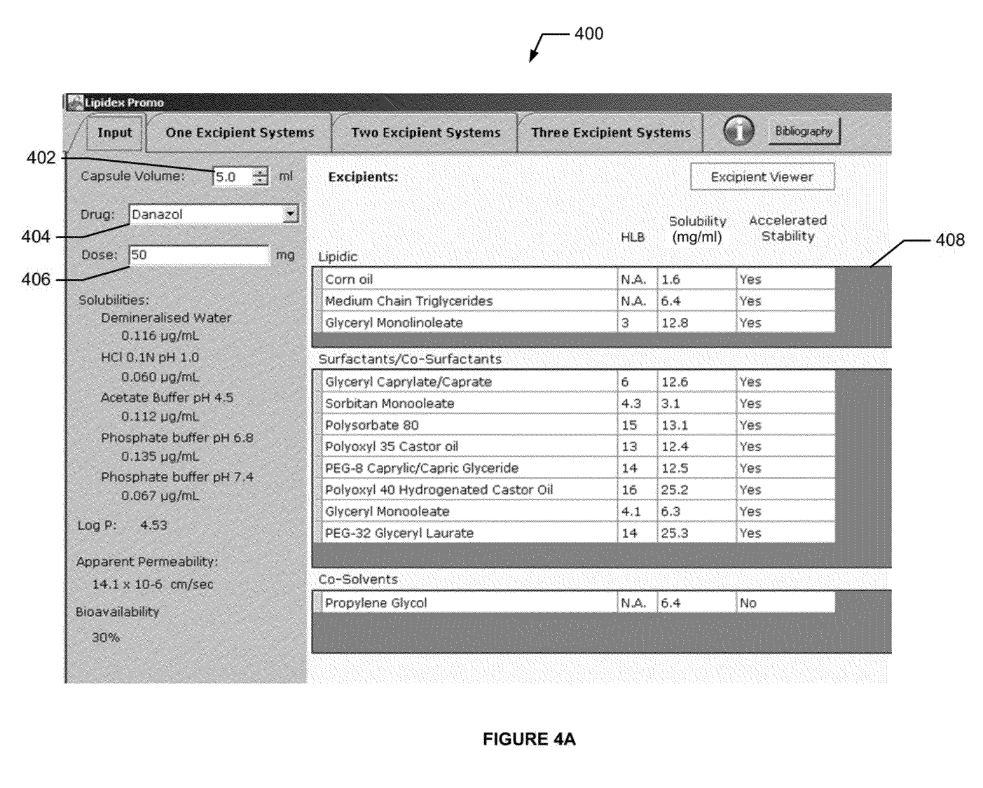

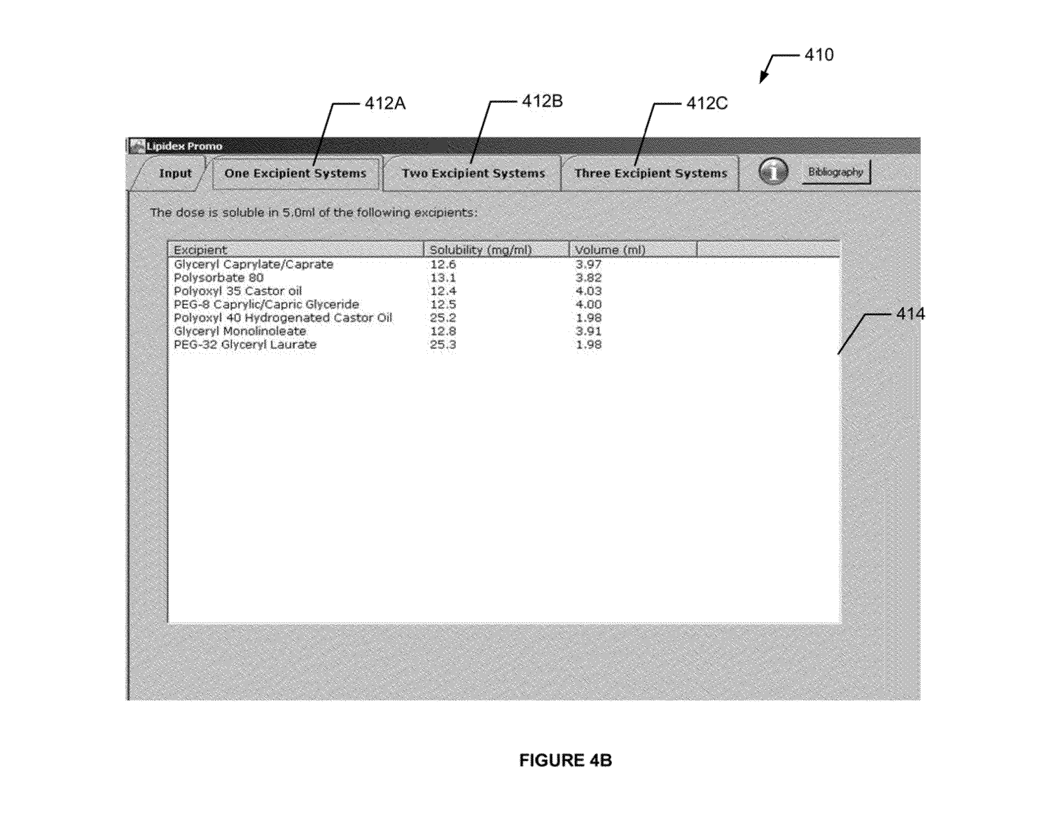

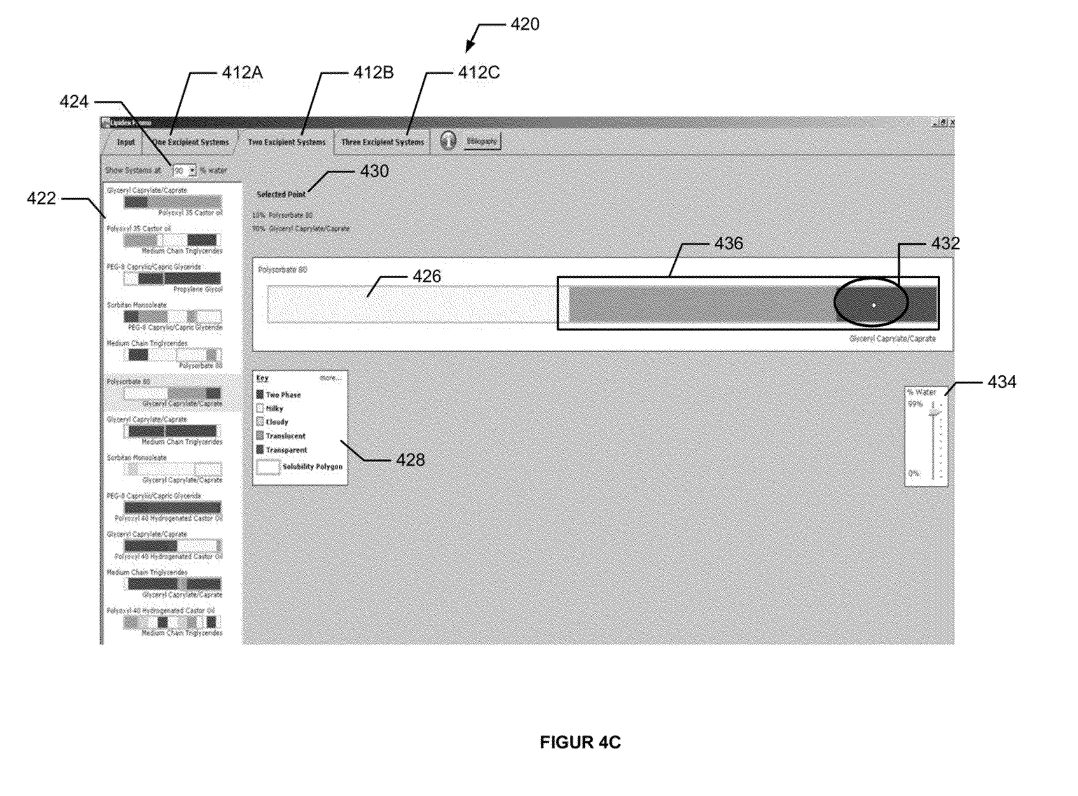

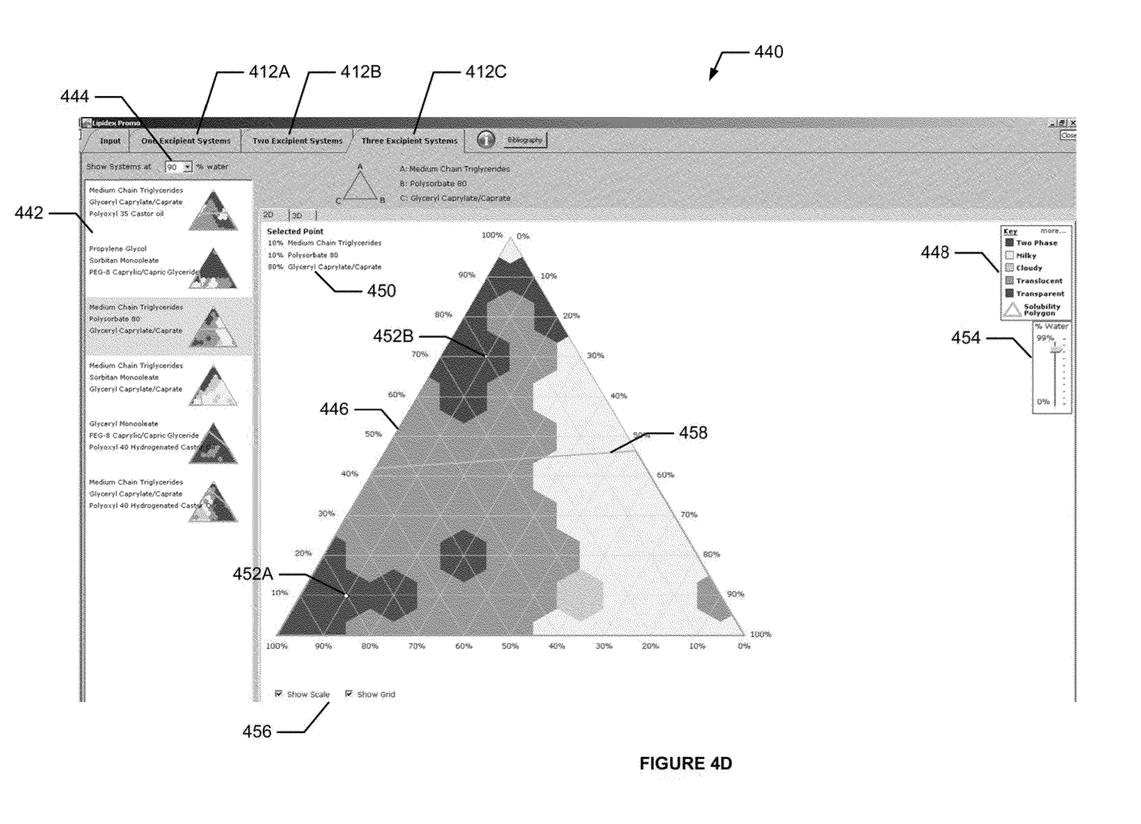

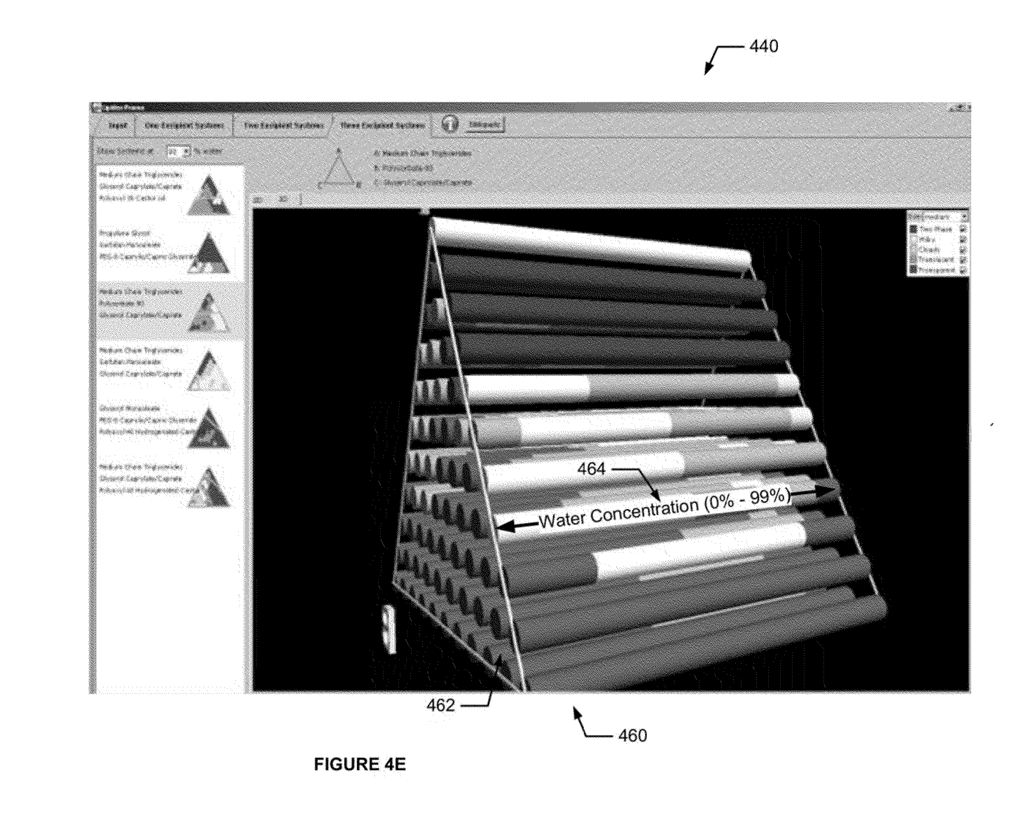

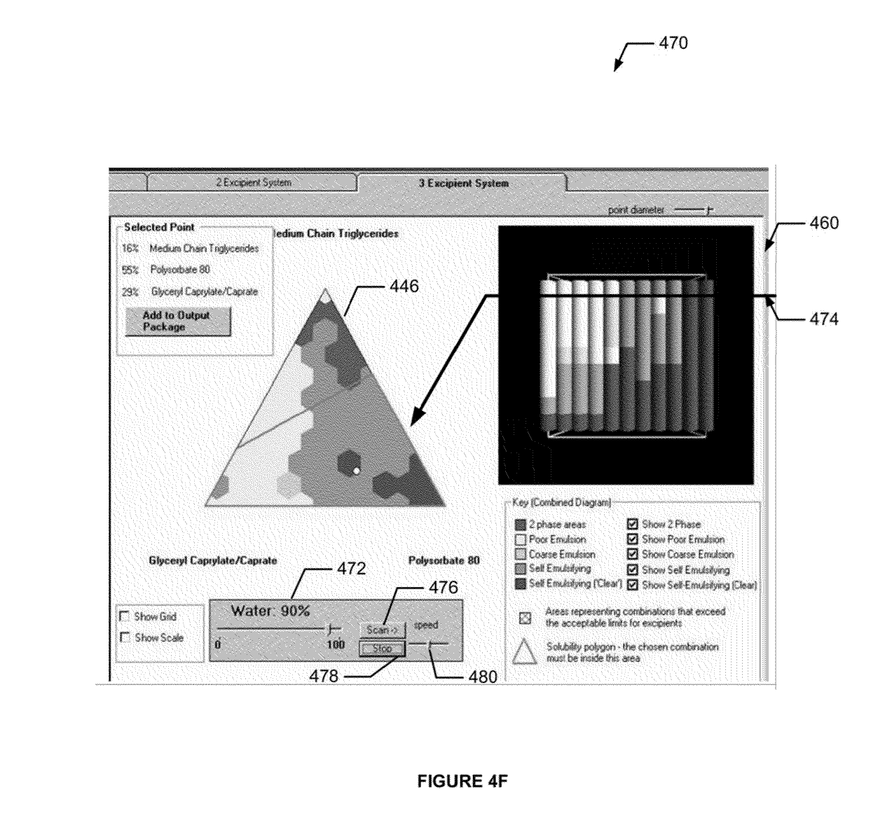

FIG. 3 illustrates a flow chart of a process 300 for modeling compound formulations. The instructions for executing process 300 may be stored in application section 204B in connection with the server application and executed by formulation processor and modeler 202. According to process 300, server 102 may provide a plurality of formulation interfaces, as shown in FIGS. 4A-4F, to interact with users. Process 300 is further described below with reference to FIGS. 3 and 4A-4F.

According to process 300, at step 302, server 102 may receive formulation data and solubility data of various pharmaceutical ingredients and excipient combinations. The formulation data may include, for example, names of individual pharmaceutical ingredients and excipients tested in essay screening experiments. The solubility data may include, for example, solubility of each pharmaceutical ingredient in an excipient combination and phase information of the formulations tested under various conditions, such as a given water concentration.

In one exemplary implementation, the formulation data and solubility data may be obtained during formulation screening experiments, such as those conducted in a laboratory. The data may be input via formulation data receiver 206 or network interface 208 from a system performing automated screening experiments and communicating with server 102.

Alternatively, the formulation data and solubility data may be received through a user input interface 400, as shown in FIG. 4A. User input interface 400 may be generated on a display device attached to server 102 through data receiver 206. Alternatively, user input interface 400 may be generated by a formulation modeling client, such as client 104, by executing the client application. Accordingly, the formulation data and the solubility data may be input by the user to the formulation modeling client and transmitted to server 102.

As shown in FIG. 4A, for example, input interface 400 generated as part of step 302 may include a plurality of input fields. The input fields may include user input elements such as drawdown menus, text boxes, and lists. In particular, user input interface 400 may include input elements 402 for the user to input a value (e.g., 5.0 ml) for capsule volume of the formulation tested in the experiments. Input elements 404 and 406 may allow the user to select and input a name (e.g., “danazol”) for the tested pharmaceutical ingredient and the tested dosage (e.g., 50 mg) of the pharmaceutical ingredient contained in the formulation. Other information of the pharmaceutical ingredient, such as its solubility in various solvents, its Log P value reflecting its lipophilicity, its apparent permeability correlating with human intestinal absorption, and its bioavailability reflecting its pharmacokinetic properties, may also be input through interface 400.

User input interface 400 may further include a data receiving area 408 for the user to input the solubility data of the tested formulation obtained during essay screening. The solubility data may include solubility of the selected pharmaceutical ingredient in (e.g., danazol) in various excipients or excipient combinations. Server 102 may present a pre-selected list of excipients or excipient combinations in data receiving area 408 for the user to input the solubility data. In one implementation, the pre-selected list includes six or more excipients or excipient combinations from which the user may select and for the system to use in generating the model. Alternatively, user input interface 400 may allow the user to input the solubility results as well as the names of individual desired excipients. Furthermore, user input interface 400 may present the excipients in different groups dependent upon their chemical or pharmaceutical properties. For example, user input interface 400 may assign the excipients to one of a lipidic group, a surfactants/co-surfactants group, and a co-solvents group as shown in FIG. 4A.

The solubility data received through interface 400 include the hydrophilic-lipophilic balance (HLB), solubility of the specified pharmaceutical ingredient, and accelerated stability of the individual excipient combinations. The HLB of an excipient measures the degree to which the excipient has hydrophilic properties, i.e., the ability to dissolve in water, or lipophilic properties or the ability to dissolve in fat, oils, lipids, etc. The solubility measures the maximum amount of the pharmaceutical ingredient that can be dissolved in a unit volume of the given excipient (e.g., corn oil). The accelerated stability indicates whether the resulting formulation is stable under the laboratory conditions.

The solubility data received through interface 400 may further include phase information of various combinations. Specifically, the phase information reflects phases of an excipient combination including two or more excipient components. For example, when two or more excipient components are combined to form an excipient combination, the combination may result in a two-phase solution, a milky solution, a cloudy solution, a translucent solution, or a transparent solution. In addition, when the excipient combination is diluted by water, the phase may change, for example, from a transparent solution to a cloudy solution. These solubility states of the resulting combinations and their diluted solutions are called phases of the combination.

As part of step 302, server 102 may also store the formulation data and the solubility data received through input interface 400 in databases 204C. The data may be stored in a known database format or in a proprietary database format for retrieval by clients 104, 106, and 108. In storing the solubility data, server 102 assigns solubility keys to each excipient or excipient combination according to the phase information. The solubility keys may be stored with the solubility data, including values indicating one of the phases (e.g., two-phase, milky, cloudy, translucent, and transparent) associated with the excipient combination. As a result, individual excipient combinations and their phases may be discovered by searching databases 204C based on the formulation parameters.

At step 304, server 102 may receive a user input from a formulation modeling client, such as client 104, 106, or 108, where the user input identifies a pharmaceutical ingredient to be used in a pharmaceutical formulation. In addition, the user input further identifies a selection of a number of excipient components to be used in the pharmaceutical formulation, as well as other compound formulation parameters. For example, the server application running on server 102 may provide a user interface (similar to the exemplary user interface shown in FIG. 4A) on a display device coupled to client 104. Through the solubility user interface, a user may specify the selections and the parameters by clicking a mouse or activating a keyboard. As shown in FIG. 4A, for example, the user may select danazol as the pharmaceutical ingredient and specify the capsule volume (e.g., 5.0 ml) and the dosage (e.g., 50 mg) for an intended formulation. The user input is then transmitted from client 104 through network 110 to server 102.

FIG. 4B illustrates an embodiment of a user interface 410 provided by server 102 for receiving the user input reflecting a selection of an excipient combination for the intended formulation. In particular, user interface 410 includes a plurality of tabs 412A-412C. By selecting individual tabs 412A-412C, the user may specify a desired compound formulation and a number of excipients to be used in the formulation. For example, the user may specify that the formulation is to be formed using the specified pharmaceutical ingredient with one excipient component, two excipient components, or three excipient components. Accordingly, the server application running on server 102 provides modeling for the specified compound formulations in one-excipient formulations, two-excipient formulations, or three-excipient formulations.

As further shown in FIG. 4B, for example, when a user selects tab 412A, the client application may provide a user input indicating that the desired compound formulation includes one excipient component. Alternatively, as shown in interfaces 420 and 440 in FIGS. 4C and 4D, the user of the client may select tabs 412B and 412C. Upon selection of tabs 412B and 412C, the client application may generate a user input specifying that modeling is desired for two-excipient compound formulations and three-excipient compound formulations, respectively.

For two and three-excipient formulations, as further shown in FIGS. 4C and 4D, the user input may further specify the individual excipient components to be used to formulate a compound. For example, user interface 420 in FIG. 4C presents a list 422 including pre-configured compound formulations for a desired two-excipient combination. Each pre-configured compound formulation in list 422 may specify a combination of two excipients, e.g., glyceryl caprylate/caprate and polyoxyl 35 castor oil. When the user selects a pre-configured compound formulation from list 422, the excipient combination corresponding to the selected compound formulation may be transmitted to server 102.

Similarly, as shown in FIG. 4D, the user may specify, through interface 440, a three-excipient formulation comprising a combination of three different excipients. For example, in the exemplary embodiment of FIG. 4D, the user may specify medium chain triglycerides, glyceryl caprylate/caprate, and polyoxyl 35 castor oil to be used to formulate a compound, by selecting the corresponding pre-configured compound formulation from a list 442.

Furthermore, the user input may include other compound formulation parameters, such as an indication of water concentration, in which a resulting pharmaceutical product is to be dissolved. The selected water concentration models a drug delivery process, in which a patient may consume the pharmaceutical product with a certain amount of water. As shown in FIGS. 4C and 4D, for example, interfaces 420 and 440 include input elements 424 and 444, respectively, for the user to specify a particular water concentration by selecting or entering a percentage number.

At step 306, based on the user input, server 102 processes the formulation data and the solubility data stored in the databases by transforming the stored data into a formulation model space that corresponds to the received compound formulation parameters. More specifically, server 102 may transform the data into the formulation model space dependent upon the number of excipients defined by the user. For a formulation requiring two or more excipients, each data point in the model space may reflect a composition of the use-selected compound using the defined number of excipients.

For example, in response to a user selecting tab 412A, which specifies a one-excipient compound formulation, server 102 may identify the solubility data corresponding to the user-specified formulation parameters and transform the solubility data into individual one-excipient formulations. According to this embodiment, the transformation of the solubility data may include filtering the stored solubility data according to the user specified formulation parameters. Specifically, the server application on server 102 may first determine the minimum solubility requirement based on the user-specified capsule volume and dosage and then compare the solubility of the pharmaceutical ingredient in each excipient with the minimum solubility requirement. Accordingly, the server application identifies one-excipient compounds, such as the glyceryl caprylate/caprate, which meet the minimum solubility requirement, and displays the identified excipients in a data model 414. Data model 414 includes the names of the available excipients and their solubility data (e.g., under the “Solubility” column) for the selected pharmaceutical ingredient. In addition, data model 414 may further include the minimum volume (e.g., under the “Volume” column) of each individual excipient needed to provide the user-specified dosage of the selected pharmaceutical ingredient.

Alternatively, as shown in FIG. 4C, when the user selects tab 412B corresponding to a two-excipient compound, server 102 may transform the stored data into a two-excipient formulation model space based on the selected excipient combination. For example, when the user input specifies a particular combination of two excipients for the compound formulation (e.g., polysorbate 80 and glyceryl caprylate/caprate, as shown in FIG. 4C), server 102 may then generate a bar element 426, reflecting a formulation model and corresponding to the formulation model space for the two excipients.

The formulation model space represented by bar element 426 may cover the entire range of the compositions for the selected excipient combination. For example, when the selected excipient combination includes polysorbate 80 and glyceryl caprylate/caprate as shown in FIG. 4C, data points of bar element 426 may represent the percentages of the individual excipient components. For example, the left most point of bar element 426 in FIG. 4C represents a combination of 100 percent of polysorbate 80 and zero percent of glyceryl caprylate/caprate. The right most point of bar element 426 represents a combination of zero percent of polysorbate 80 and 100 percent of glyceryl caprylate/caprate. Similarly, the middle point of bar element 426 represents a combination of 50 percent of polysorbate 80 and 50 percent of glyceryl caprylate/caprate. The composition of the excipient combination may vary linearly along bar element 426. Alternatively, the percentages of the excipient components in the combination can vary non-linearly along bar element 426.

Still alternatively, bar element 426 may represent a partial range of the compositions of the selected excipient combinations. For example, bar element 426 may represent the compositions varying between a combination of 20 percent of polysorbate 80 and 80 percent of glyceryl caprylate/caprate and a combination of 80 percent of polysorbate 80 and 20 percent of glyceryl caprylate/caprate.

As shown in FIG. 4D, a user may also select tab 412C corresponding to a three-excipient compound formulation. In such a case, server 102 may then transform the stored data of the database into a formulation model space corresponding to three excipients. For example, as shown FIG. 4D, server 102 may generate a triangle element 426 for representing a ternary diagram of the selected excipient combination. The ternary diagram may be a barycentric plot of the three excipients, where the percentages of the three excipients sum to a constant, e.g., 100 percent. Accordingly, data points of the ternary diagram may represent the percentages of the three selected excipients in an equilateral triangle. Each data point on the ternary diagram thus represents a different composition of the three-excipient combination.

In the example of FIG. 4D, for instance, the selected excipient combination includes three excipient components: medium chain triglycerides, polysorbate 80, and glyceryl caprylate/caprate. According to the ternary diagram, point 452A of triangle element 425 represents a combination of 10 percent of medium chain triglycerides, 10 percent of polysorbate 80, and 80 percent of glyceryl caprylate/caprate. Point 452B, as another example, represents a combination of 10 percent of medium chain triglycerides, 70 percent of polysorbate 80, and 20 percent of glyceryl caprylate/caprate.

At step 308, server 102 generates a compound formulation model based on the formulation model space, reflecting the formulation data and the solubility data. As shown in FIG. 4B, for example, for a one-excipient compound, the compound formulation model may include the data model 414 displayed within tab 412B on user interface 410. Alternatively, data model 414 may be displayed in a separate interface. In one implementation, data model 414 may simply list the available excipients that satisfies the formulation parameters specified by the user.

For a compound formulation including two or more excipient components, such as the two-excipient formulations or three-excipient formulations, the selected excipient components may produce various phases when they are mixed. The phase of the combined solution may be two phase, milky, cloudy, translucent, or transparent. In addition, the phase of the combined solution may depend upon the water concentration added in diluting the combination. When the water concentration is varied, the combined solution may change from one phase (e.g., transparent) to another phase (e.g., milky).

In determining the phases for the data points in the formulation model space, server 102 may search the databases in data section 204C of FIG. 2 to determine the phases of the selected compound formulation corresponding to a specified water concentration. For a two-excipient compound as shown in FIG. 4C, server 102 searches databases 204C for the solubility data corresponding to the selected combination of the two specified excipients, e.g., polysorbate 80 and glycerol caprylate/caprate. Through the search, server 102 may determine the solubility keys indicating the phase information of the selected excipient combination with a range of compositions and water concentrations.

Similarly, as shown in FIG. 4D, when the user input specifies a three-excipient system, server 102 may search in databases 204C for the solubility data corresponding to the selected three-excipient combination. Based on the phase information discovered in the search, server 102 generates a compound formulation model reflecting the phases of the selected excipient combination and presents the compound formulation model to the user.

For two-excipient compounds, as shown in FIG. 4C, server 102 generates the compound formulation model by color coding bar element 426 according to the solubility keys associated with the selected excipient combination and the water concentration specified in the user input. For the example shown in FIG. 4C, server 102 may thus determine, based on the solubility data, that the excipient combination of zero percent of polysorbate 80 and 100 percent of glyceryl caprylate/caprate produces a transparent solution with a 90 percent water concentration. As a result, server 102 may assign a blue color code to the corresponding section, i.e., the right most section, of bar element 426.

On the other hand, server 102 may determine, based on the solubility data, that the excipient combination of 50 percent polysorbate 80 and 50 percent glyceryl caprylate/caprate results in a translucent solution with the 90 percent water concentration. Accordingly, server 102 may assign a green color code to the middle section of bar element 426. Similarly, server 102 may determine, based on the solubility data, that the excipient combination of 100 percent of polysorbate 80 and zero percent of glyceryl caprylate/caprate results in a milky solution with the 90 percent water concentration. Accordingly, server 102 may assign a yellow color code to the left most section of bar element 426.

After the color coding, server 102 may transmit the compound formulation model to the formulation modeling clients and instruct the clients to display the model as part of the user interface, e.g., interface 420. As a result, bar element 426 and the color codes assigned to it provide a graphical model of the selected excipient combination and a correlation between the phases and the compositions (e.g., percentages of each excipient components) of the selected compound formulation.

According to the color coding scheme described above, the color codes are assigned to sections of bar element 426 according to the phases represented by the solubility keys in the solubility data. The values of the solubility keys, including “two phase,” “milky,” “cloudy,” “translucent,” and “transparent,” may be represented by different colors or different shades of color, such as different shades of blue. Interface 420 further provides a legend 428 of the color codes assigned to the solubility keys, as shown in FIG. 4C.

According to a further embodiment, other coding scheme may be applied to the compound formulation model to distinguish different phases of the selected excipient combination. For example, server 102 may assign different image patterns to different sections of bar element 426 according to the solubility keys of the selected excipient combination. The image patterns may be dots in different sizes, hash lines with different spacing or directions, or different texture patterns.

According to a further embodiment shown in FIG. 4C, server 102 provides additional elements on interface 420 to allow further interactions with the user of the client. For example, interface 420 allows a user to select a data point on bar element 426 by using an input device, such as a mouse or a keyboard. In response, information, such as the composition, represented by the selected data point is presented to the user through text 430 displayed on interface 420. As a result, interface 420 allows a user to select a specific composition of the excipient combination with a desired phase.

According to a still further embodiment, server 102 may provide additional elements to model a drug delivery process by varying the water concentration used in diluting the excipient combination. Specifically, when a different percentage of water is added to the combined solution of the excipient components, the phase of the combined solution may change. In response, server 102 may update the compound formulation model based on the newly specified water concentration. For example, as shown in FIG. 4C, interface 420 may include a sliding bar element 434. Bar element 434 includes a tab indicating the current water concentration, which is to be used to dilute the excipient combination.

The user may increase or decrease the water concentration by sliding the tab of sliding bar element 434. By setting a new water concentration through sliding bar element 434, the user may request server 102 to update the compound formulation model to reflect the newly set water concentration. In response, server 102 searches the phase information in the databases to determine the solubility keys based on the newly set water concentration. Server 102 may then update the coding of the compound formulation model according to the solubility keys of the newly retrieved data. More specifically, when the user varies the water concentration from zero percent to 99 percent, server 102 sequentially presents the compound formulation model corresponding to each percentage value, simulating the gradual increase of the water concentration when a patient consumes the pharmaceutical product with water.

Alternatively, as shown in FIG. 4D, for a three-excipient compound formulation, server 102 may generate a compound formulation model reflecting the phases of the excipient combination by color coding triangle element 446 according to the solubility keys discovered from the databases. For example, server 102 determines, based on the solubility keys, that the composition of the selected excipient combination indicated by data point 452A produces a transparent solution with a 90 percent water concentration. Accordingly, server 102 assigns a blue color code to the corresponding section surrounding data point 452A. As another example, server 102 determines, based on the solubility keys, that the composition of the selected excipient combination indicated by data point 452B results in a two-phase solution with the 90 percent water concentration. Accordingly, server 102 assigns a red color code to the corresponding section surrounding data point 452B.

When the entire triangle element 446 is coded, server 102 transmits the compound formulation model to a client and presents the model to the user through user interface 440. As a result, triangle element 446 and the color codes assigned to it provide a graphical model for the selected excipient combination and the correlation between the phase and the compositions of the selected excipient combination. Similar to interface 420, interface 440 may further provide a legend 448 of the color codes assigned to the solubility keys, as shown in FIG. 4D.

According to a further embodiment shown in FIG. 4D, server 102 may allow additional interactions with the user. For example, server 102 allows the user of the client to select a data point, such as data point 452A, of triangle element 446 by using an input device. In response, information, such as the composition of the compound formulation corresponding to the selected data point, is displayed through text 450. As a result, interface 440 allows the user to directly visualize and determine a composition of a formulation and the phase information of the selected composition.

Additionally, server 102 may further allow the user to change the water concentration, which is to be combined with the excipient combination and update the compound formulation model accordingly. As shown in FIG. 4D, for example, the user may increase or decrease the water concentration by operating a sliding bar element 454. When the user sets a new water concentration through sliding bar element 454, server 102 searches the solubility data in the databases to determine the phase information based on the newly set water concentration. Based on the search results, server 102 updates the compound formulation model to reflect the updated solubility keys. Thus, the color codes assigned to triangle element 446 are updated according to the selected excipient combination and the newly set water concentration.

As further shown in FIG. 4D, interface 440 may also include additional elements, such as check box elements 456 that allow the user to change the display properties of triangle element 446. For example, in response to a user selection of one of check box elements 456, interface 440 may show or hide the scale or the grid in triangle element 446.

At step 310, server 102 identifies excipient combinations that satisfy the formulation parameters based on the compound formulation model. For one-excipient formulations as shown in FIG. 4B, the identification of the excipient combinations is performed as part of the filtering step described above. Specifically, by comparing the formulation parameters with the solubility of the pharmaceutical ingredient in each individual excipient, server 102 may identify the excipients that meet the formulation requirements specified by the user.

For the compound formulation models shown in FIGS. 4C and 4D, server 102 may generate a solubility polygon for the excipient combination based on the user-specified formulation parameters. Because the solubility of a given pharmaceutical ingredient in each individual excipient may be different (as shown in FIG. 4A), the maximum amount of the pharmaceutical ingredient that can be dissolved in a given excipient combination may vary as the composition changes. For example, a given volume of excipient combination with 10 percent of corn oil and 90 percent of glyceryl monolinoleate may dissolve a greater amount of danazol than the same volume of excipient combination with 90 percent of corn oil and 10 percent of glyceryl monolinoleate. This is because danazol has a greater solubility in glyceryl monolinoleate than in corn oil.

The solubility polygon generated by server 102 indicates the compositions of the excipient combination that are capable of satisfying the user-specified requirements (e.g., dosage and capsule volume), when the pharmaceutical ingredient is dissolved in an excipient combination. As shown in FIG. 4C, a solubility polygon 436 may have a rectangular shape that encloses a portion of compound formulation model 426.

In generating solubility polygon 436, server 102 may first calculate a maximum dissolvable amount of the selected pharmaceutical ingredient in a particular composition of the excipient combination. As shown in FIG. 4C, for example, the user specifies a capsule volume of 50 ml and a dosage of 50 mg for danazol. In the example, server 102 may first calculate the maximum dissolvable amount of danazol in 20 percent (i.e., 10 ml) of polysorbate 80 and 80 percent (i.e., 40 ml) of glyceryl caprylate/caprate. This can be calculated by multiplying the solubility for an individual excipient with the volume of the excipient.

Server 102 may then compare the maximum dissolvable amount calculated with the user-specified dosage and determine whether the former is greater or less than the latter. If the maximum dissolvable amount is greater than the user-specified dosage, server 102 may include, in solubility polygon 436, the data point corresponding to 20 percent of polysorbate 80 and 80 percent of glyceryl caprylate/caprate, indicating that the composition indicated by the data point satisfies the formulation parameters. Otherwise, server 102 may not include the data point in solubility polygon 436.

Accordingly, server 102 may identify all data points corresponding to compositions that provide sufficient maximum dissolvable amounts for a given pharmaceutical ingredient and include these data points in solubility polygon 436. Server 102 may present solubility polygon 436 as a graphical element on interface 420 as shown in FIG. 4C and overlay the graphical element on formulation model 426.

As a result, formulation model 426 may allow a user to visually determine the compositions of the selected excipient combination that are capable of providing a desired phase as well as a satisfactory dosage specified by the user. Specifically, the color codes of formulation model 426 may provide identification of compositions with the desired phase information (e.g., transparent). In addition, solubility polygon 436 may provide identifications of compositions that satisfy the dosage requirement specified by the user. For example, based on formulation model 426, a user can quickly identify point 432 as a viable composition for the combination of polysorbate 80 and glyceryl caprylate/caprate, because it is within solubility polygon 436 and corresponds to a transparent solution indicated by the color code.

According to another embodiment, FIG. 4D shows a solubility polygon 458 for a three-excipient combination. Solubility polygon 458 may enclose a portion of compound formulation model 446. Similarly to solubility polygon 436 in FIG. 4C, solubility polygon 458 may include data points corresponding to the compositions of a three-excipient combination that are capable of providing the formulation parameters specified by a user.

As shown in FIG. 4D, for example, the user specifies a formulation including a capsule volume of 50 ml and a dosage of 50 mg for danazol. Accordingly, server 102 may calculate the maximum dissolvable amount of danazol for 10 percent (i.e., 5 ml) of medium chain triglycerides, 10 percent (i.e., 5 ml) of polysorbate 80, and 80 percent (i.e., 40 ml) of glyceryl caprylate/caprate. Server 102 may then compare the maximum dissolvable amount so calculated with the user-specified dosage and determines whether the former is greater or less than the latter. If the maximum dissolvable amount is greater than the user-specified dosage, server 102 may include, in solubility polygon 458, the data point (i.e., point 452A) corresponding to 10 percent of medium chain triglycerides, 10 percent of polysorbate 80, and 80 percent of glyceryl caprylate/caprate. Otherwise, server 102 may not include the data point in solubility polygon 458.

Accordingly, server 102 may identify all data points corresponding to compositions that provide sufficient maximum dissolvable amounts for a given pharmaceutical ingredient and include these data points in solubility polygon 458. Server 102 may present solubility polygon 458 as a graphical element on interface 440 as shown in FIG. 4D and overlay the graphical element on formulation model 446.

Similar to formulation model 426, formulation model 446 shows a graphical representation of the compositions of the selected three-excipient combination that are capable of providing a desired phase as well as a satisfactory dosage. For example, based on formulation model 458, the system allows identification of point 452A as a viable composition for the combination of medium chain triglycerides, polysorbate 80, and glyceryl caprylate/caprate, because point 452A is within solubility polygon 458 and corresponds to a transparent solution as indicated by the color code.

According to a still further embodiment, as shown in FIG. 4E, server 102 may generates, as part of step 310, a three-dimensional solubility model 460 to provide identifications of available compositions. Such a three-dimensional model may incorporate as a third dimension the values of the solubility keys determined for each excipient combination and a range of water concentrations. Specifically, each cross section 462 of three-dimensional solubility model 460 includes a ternary diagram similar to that shown in FIG. 4D. Different cross sections of three-dimensional solubility model 460 corresponds to compound formulations as diluted with different water concentrations.

Additionally, data points on each cross section 462 of three-dimensional model 460 may be color coded according to the solubility keys of the excipient combination. In this exemplary embodiment, a third dimension 464 of three-dimensional solubility model 460 represents the range of the water concentration, e.g., between 0 percent and 99 percent. As a result, three-dimensional solubility model 460 may indicate a correlation between the phase and the composition of the selected excipient combination, as well as a correlation between the phase and the water concentrations used to dilute the excipient combination.

According to a still further embodiment shown in FIG. 4F, triangle element 446 and three-dimensional solubility model 460 may be presented simultaneously in an interface 470. Similar to interface 440 shown in FIG. 4D, interface 470 may also include a sliding bar element 472, which allows the user to adjust the water concentration to be combined with the selected excipient combination. Additionally, interface 470 may include a line element 474 as part of three-dimensional model 460 indicating a location of the cross section corresponding to a given water concentration.

Still additionally, interface 470 may include control elements, such as a scan button 476, a stop button 478, and a speed bar element 480, which allow the user to control an automatic scanning process through three-dimensional model 460. For example, when the user activates scan button 476 by using an input device, the client application may start the automatic scanning process, which sequentially displays in triangle element 446 the cross sections of three-dimensional formulation model 460. Simultaneously, line element 474 may be moved through three-dimensional model 460 indicating the location of the cross section being displayed in triangle element 446.

The automatic scanning process may simulate the drug delivery process when a patient consumes a pharmaceutical product with water as discussed above. Accordingly, the automatic scanning process allows the user to visualize and determine the phases of the selected excipient combination in the entire range of the water concentration. In addition, the automatic scanning process allows the user to identify compositions of the excipient combination that are capable of producing a desired phase (e.g., transparent) in the entire range of water concentration. For example, through the automatic scanning process, the user may identify a region of triangle element 446 that is always coded with the color code associated with the “transparent” solubility key. As such, the identified region corresponds to desired compositions of the excipient combination that would produce a transparent solution in a subsequent drug development stage and during drug delivery. In addition, the user may stop the automatic scanning process by activating stop button 478 and adjust the scanning speed by adjusting the tab along speed bar element 480 through an input device.

As described above, server 102, by running the server application, may provide estimations on phases based on the compound formulation models. In response to the user input, server 102 may transform the solubility data and generates a compound formulation model as shown in FIGS. 4A-4F. Based on the compound formulation model, the user may identify specific compositions of the selected excipient combinations that would produce desired phases and provide desired dosage without carrying out physical screening experiments, which are expensive and time consuming.

For example, system 100 may be used by a service provider to provide formulation modeling services for drug manufacturers and developers to identify excipient combinations with desired pharmaceutical properties during new drug development. Specifically, the service provider may conduct the laboratory experiments to collects the formulation data and the solubility data of a large amount of pharmaceutical ingredient and excipients. The data are then stored in the databases on server 102 and provided to the drug developers through the formulation modeling server and client applications.

When a user, e.g., a drug developer, seeks new drug formulations, the user may access the data through the client application on a formulation modeling client shown in FIG. 1 according to the process described above. As a result, the user may identify desired compositions of the excipient combinations for the new formulations without having to conduct expensive laboratory experiments.

Other embodiments of the disclosure will be apparent to those skilled in the art from consideration of the specification and practice of the embodiments disclosed herein. It is intended that the specification and examples be considered as exemplary only, with a true scope and spirit of the disclosure being indicated by the following claims.

What is claimed is:

1. A method for modeling a compound formulation, comprising:
receiving compound parameters, including an excipient parameter identifying an excipient combination to be used in developing the compound formulation and a water concentration parameter identifying a water concentration to be used in diluting the excipient combination;
storing, in a database, formulation data associated with a plurality of excipient combinations and solubility data associated with a plurality of pharmaceutical ingredients dissolved in the respective excipient combinations;
transforming the formulation data and the solubility data into a formulation model space, where points in the formulation model space reflect compositions of the identified excipient combination; and
generating a compound formulation model based on the formulation model space, where the compound formulation model graphically identifies one or more compositions of the identified excipient combination that satisfy the compound parameters.

2. The method of claim 1, wherein:
the excipient combination includes a plurality of excipient components;
the compound formulation model includes a plurality of solubility keys that graphically display a range of possible phases for the identified excipient combination; and
each solubility key includes a value indicating a phase of the excipient combination with a specified composition, the specified composition including specified percentages of the excipient components.

3. The method of claim 2, wherein the compound formulation model includes a graphical element, and the method further comprises color coding the graphical element based on the solubility data.

4. The method of claim 3, wherein:
the phases corresponding to the solubility keys include at least a transparent solution, a translucent solution, a milky solution, a cloudy solution, or a two-phase solution; and
the method further comprises assigning different color codes to the solubility keys.

5. The method of claim 2, wherein:
the excipient combination includes a first excipient component and a second excipient component; and
the compound formulation model includes a bar element representing the formulation model space.

6. The method of claim 5, wherein:
the bar element has a first end point corresponding to a zero percent of the first excipient component and a 100 percent of the second excipient component in the excipient combination and a second end point corresponding to a 100 percent of the first excipient component and a zero percent of the second excipient component.

7. The method of claim 2, wherein:
the excipient combination includes a third excipient component; and
the compound formulation model includes a ternary diagram representing the formulation model space.

8. The method of claim 2, further comprising:
receiving a selection input, the selection input identifying a user-selected data point on the compound formulation model; and
displaying a composition of the excipient combination corresponding to the user-selected data point.

9. The method of claim 2, further comprising:
receiving an adjustment input, the adjustment input including an updated water concentration to be combined with the excipient combination;
determining additional phases in the experiment data based on the updated water concentration; and
updating the compound formulation model based on the additional phases.

10. The method of claim 9, wherein the receiving of the adjustment input further comprises:
automatically changing the water concentration in a continuous range; and
sequentially displaying the updated compound formulation model as the water contraction is changed.

11. The method of claim 10, wherein the continuous range is between zero percent and 99 percent.

12. The method of claim 11, wherein the compound formulation model includes a three-dimensional formulation model, the three-dimensional formulation model including a continuous range of the water concentration, the three-dimensional formulation model being color coded based on the solubility keys within the continuous range of the water concentration.

13. The method of claim 1, wherein the compound parameters specify an identifier of a pharmaceutical ingredient, a capsule volume of a pharmaceutical product including the pharmaceutical ingredient, and a dosage of the pharmaceutical ingredient.

14. The method of claim 13, wherein the compound formulation model further includes a solubility polygon indicating compositions of the excipient combination that are capable of providing the dosage specified in the compound parameters.

15. The method of claim 14, further comprising:
calculating a maximum soluble amount of the pharmaceutical ingredient in the identified excipient combination;
comparing the maximum soluble amount with the dosage specified in the compound parameters; and
including, in the solubility polygon, a point of the compound formulation model corresponding to the identified excipient combination if the maximum soluble amount is greater than the dosage.

16. A non-transitory computer-readable medium comprising instructions, which, when executed by one or more processors, causes the one or more processor to perform a method for modeling a compound formulation, comprising:
receiving compound parameters, including an excipient parameter identifying an excipient combination to be used in developing the compound formulation and a water concentration parameter identifying a water concentration to be used in diluting the excipient combination;
storing, in a database, formulation data associated with a plurality of excipient combinations and solubility data associated with a plurality of pharmaceutical ingredients dissolved in the respective excipient combinations;
transforming the formulation data and the solubility data into a formulation model space, where points in the formulation model space reflect compositions of the identified excipient combination; and
generating a compound formulation model based on the formulation model space, where the compound formulation model graphically identifies one or more compositions of the identified excipient combination that satisfy the compound parameters.

17. The non-transitory computer-readable medium of claim 16, wherein:
the excipient combination includes a plurality of excipient components;
the compound formulation model includes a plurality of solubility keys that graphically display a range of possible phases for the identified excipient combination; and
each solubility key includes a value indicating a phase of the excipient combination with a specified composition, the specified composition including specified percentages of the excipient components.

18. The non-transitory computer-readable medium of claim 17, wherein the compound formulation model includes a graphical element, and the method further comprises color coding the graphical element based on the solubility data.

19. The non-transitory computer-readable medium of claim 18, wherein:
the phases corresponding to the solubility keys include at least a transparent solution, a translucent solution, a milky solution, a cloudy solution, or a two-phase solution; and
the method further comprises assigning different color codes to the solubility keys.

20. The non-transitory computer-readable medium of claim 17, wherein:
the excipient combination includes a first excipient component and a second excipient component; and
the compound formulation model includes a bar element representing the formulation model space.

21. The non-transitory computer-readable medium of claim 20, wherein:
the bar element has a first end point corresponding to a zero percent of the first excipient component and a 100 percent of the second excipient component in the excipient combination and a second end point corresponding to a 100 percent of the first excipient component and a zero percent of the second excipient component.

22. The non-transitory computer-readable medium of claim 17, wherein:
the excipient combination includes a third excipient component; and
the compound formulation model includes a ternary diagram representing the formulation model space.

23. The non-transitory computer-readable medium of claim 17, wherein the method further comprises:
receiving a selection input, the selection input identifying a user-selected data point on the compound formulation model; and
displaying a composition of the excipient combination corresponding to the user-selected data point.

24. The non-transitory computer-readable medium of claim 16, wherein the method further comprises:
receiving an adjustment input, the adjustment input including an updated water concentration to be combined with the excipient combination;
determining additional phases in the experiment data based on the updated water concentration; and
updating the compound formulation model based on the additional phases.

25. The non-transitory computer-readable medium of claim 24, wherein the receiving of the adjustment input further comprises:
automatically changing the water concentration in a continuous range; and
sequentially displaying the updated compound formulation model as the water contraction is changed.

26. The non-transitory computer-readable medium of claim 25, wherein the continuous range is between zero percent and 99 percent.

27. The non-transitory computer-readable medium of claim 26, wherein the compound formulation model includes a three-dimensional formulation model, the three-dimensional formulation model including a continuous range of the water concentration, the three-dimensional formulation model being color coded based on the solubility keys within the continuous range of the water concentration.

28. The non-transitory computer-readable medium of claim 16, wherein the compound parameters specify an identifier of a pharmaceutical ingredient, a capsule volume of a pharmaceutical product including the pharmaceutical ingredient, and a dosage of the pharmaceutical ingredient.

29. The non-transitory computer-readable medium of claim 16, wherein the compound formulation model further includes a solubility polygon indicating compositions of the excipient combination that are capable of providing the dosage specified in the compound parameters.

30. The non-transitory computer-readable medium of claim 29, wherein the method further comprising:
calculating a maximum soluble amount of the pharmaceutical ingredient in the identified excipient combination;
comparing the maximum soluble amount with the dosage specified in the compound parameters; and
including, in the solubility polygon, a point in the compound formulation model corresponding to the identified excipient combination if the maximum soluble amount is greater than the dosage.
